(19) United States
(12) Patent Application Publication
(10) Pub. No.: US 2025/0156538 A1
(43) Pub. Date: May 15, 2025

(54) DEVICE AND PROCESS FOR EXECUTING CYBERSECURITY FUNCTIONS AND SAFETY FUNCTIONS

(71) Applicant: Dräger Safety AG & Co. KGaA, Lübeck (DE)

(72) Inventors: Tino SCHRÖDER, Lübeck (DE); Sebastian DRAACK, Lübeck (DE); Justus HARNEID, Lübeck (DE); Till ZICKMANTEL, Lübeck (DE); Kim KULLING, Lübeck (DE)

(21) Appl. No.: 18/945,881

(22) Filed: Nov. 13, 2024

(30) Foreign Application Priority Data
Nov. 14, 2023 (DE) 10 2023 131 634.6

(51) Int. Cl. G06F 21/55; G05B 9/02

(52) U.S. Cl. CPC G06F 21/554; G05B 9/02

(57) ABSTRACT

A device (10) executes cybersecurity functions with respect to information security and safety functions with respect to operational safety. The device includes a first computing unit (1) for executing at least one of the cybersecurity functions and includes a second computing unit (2) for executing at least one of the safety functions. The first computing unit includes a communication module (3) which has a first interface (5) and is configured to check incoming data. The second computing unit includes an alarm module (4) which is configured to generate an information signal (INS). The first computing unit and the second computing unit are connected to one another via a second interface (6) for data exchange. A process executes cybersecurity functions and safety functions on such a device. A gas measuring device (20) and a ventilator or anesthesia device (30) are provided with such a device.

### CROSS REFERENCE TO RELATED APPLICATIONS

This application claims the benefit of priority under 35 U.S.C. § 119 of German Application 102023131634.6, filed Nov. 14, 2023, the entire contents of which are incorporated herein by reference.

### TECHNICAL FIELD

The present invention relates to a device and a process for performing cybersecurity functions and safety functions. The invention also relates to a gas measuring device and a ventilator or anesthesia device with such a device.

### BACKGROUND

Cybersecurity and cybersecurity functions are becoming increasingly important, especially in the age of digitalization and the ever more extensive networking of devices with internet-based platforms. Cybersecurity, synonymous with IT security, is intended to ensure the information security of systems and devices. The aim is to ensure the availability, confidentiality and integrity of information. A key aspect of this is protection against attacks that can be used to manipulate information and thus cause major damage. Cybersecurity functions are primarily measures that enable devices or systems to be protected against such attacks.

In contrast, safety functions are particularly concerned with protecting living beings and the environment from potential hazards. Safety functions, also known as functional safety, are intended to ensure operational safety. Hazards should be prevented as far as possible or, if this is not possible, at least pointed out so that countermeasures can be initiated. Due to the great importance of safety functions, they are subject to special regulations such as norms and standards, especially in industrial and medical environments. A distinction is often made between different risk areas, with high requirements being placed on safety functions in areas where there is a risk to life and limb. In contrast, there are currently only a few regulations regarding cybersecurity functions, depending on the area of application. However, it can be assumed that this will change in the future due to the ever-increasing relevance. This makes it all the more important to consider the interaction of security and safety functions.

Compliance with the respective regulations relating to safety functions is usually checked by a specialized approval body. This is often associated with increased effort, particularly in gas measurement technology and medical technology, as the proper functioning must be ensured and tested. Accordingly, the process of approving a device or system with regard to a standard usually takes a long time on the part of the manufacturer and the approval body. Times of several weeks to several months are common.

This high time expenditure is offset by the need to rectify any problems that arise with regard to cybersecurity and technical progress as quickly as possible, especially for devices or systems already on the market. The aim in this case is to prevent or at least limit damage, usually of an economic nature. It is also necessary to keep cybersecurity functions up to date, for example by regularly providing software updates for devices and systems in order to counter technical developments and thus also possible new problems with regard to cybersecurity, such as new types of attacks.

### SUMMARY

It is an object of the invention to provide a device and a process for executing cybersecurity functions and safety functions, whereby the cybersecurity functions, in particular of devices or systems on the market, should be able to be changed in a short time, for example in the form of a software update. It should be possible to make these changes independently of the safety functions, so that the safety functions are not affected by the changes to the cybersecurity functions. This should ensure that the safety functions continue to comply with the regulations checked by the approval body, so that at best no new approval is required, and that a change to the cybersecurity functions, for example in the form of a software update of a device or system on the market, can be implemented as quickly as possible. This should result in an improvement in the availability of a device with current cybersecurity functions and approval-compliant safety functions.

The above task is solved by a device for executing cybersecurity functions and safety functions with device features according to the invention, a process for executing cybersecurity functions and safety functions with process features according to the invention, a gas measuring device with gas measuring device features according to the invention, and a ventilator or anesthesia device with ventilator or anesthesia device features according to the invention. Further details of the invention and embodiments thereof are disclosed in the description, the drawings and the claims. Features and details that are described in connection with the device according to the invention also apply in connection with the process according to the invention, gas measuring device and ventilator or anesthesia device, so that reference is always made or rather can be made mutually with respect to the disclosure of the individual aspects of the invention.

The device according to the invention for executing cybersecurity functions with respect to (in the sense of/in terms of) information security and safety functions with respect to (in the sense of/in terms of) operational safety has a first computing unit for executing at least one of the cybersecurity functions and a second computing unit for executing at least one of the safety functions. The first computing unit comprises a communication module that has a first interface and is configured to check incoming data. The second computing unit comprises an alarm module, which is configured to generate an information signal. In addition, the first computing unit and the second computing unit are connected to each other via an interface for data exchange.

Cybersecurity is to be understood as a form of information security, whereas safety is to be understood as a form of operational safety.

Accordingly, cybersecurity functions include measures to protect information, especially electronic data, from being modified or accessed by unauthorized persons. Such measures include, for example, encrypting data or authenticating communication partners.

Safety functions include measures for the direct or indirect protection of living beings or objects from potential hazards, such as toxic or flammable gases, inadequate care for a patient during ventilation or other hazards that could lead to injury or damage. Direct protection means the avoidance of hazards, whereby an action is carried out that renders the hazard harmless. Indirect protection, on the other hand, means indicating an imminent danger and/or warning of an imminent danger, whereby information indicating a danger is output. Examples of safety functions include activating a ventilator system in the event of a dangerous gas concentration in a production hall or raising the alarm (alerting) in such a case, activating an emergency gas supply if the primary gas supply to a ventilator or anesthesia device fails, or raising the alarm if ventilation parameters are in an impermissible or dangerous range for the patient.

A computing unit is a unit for executing a computer program or for executing software. A computing unit can be configured as a processor, microprocessor, central processing unit (CPU) or processor core. Other programmable computing units (processors) as a form of computer, in particular field programmable gate arrays (FPGA) or application-specific integrated circuits (ASIC), are conceivable. An essential feature of the computing unit according to the invention is its ability to execute a computer program or software independently, in particular independently of other computing units.

The first computing unit and the second computing unit are preferably two microprocessors that are connected to each other via the second interface. It is also conceivable that the first and second computing units are configured as first and second processor cores on a processor or microprocessor. Other variants in which, for example, the first computing unit is configured as a microprocessor and the second computing unit is configured as an FPGA or the first computing unit is configured as an ASIC and the second computing unit is configured as a processor core of a microprocessor are also conceivable. What is essential here is that the first and second computing units are separate from each other in terms of the hardware. This results in the particular advantage that computer program products or software for executing the cybersecurity or safety functions are essentially independent of each other due to the separation of the first and second computing units on the hardware side. They can be developed and/or modified separately and can run independently of each other. The second interface, which connects the first and second computing units for data exchange, enables the computer programs of the first and second computing units to influence each other. However, such an influence is only possible to a predetermined extent during the development of the computer programs and is therefore predetermined, so that subsequent changes to the respective computer program must be based on the predetermined interface properties and interface functions. This also has the advantage that the computer programs that implement the cybersecurity and safety functions of the first and second computer units can be modified separately. It is therefore possible to change a first computer program of the first computing unit without having to change a second, already existing computer program of the second computing unit. In an advantageous manner, it is therefore possible to have different change cycles for a respective computer program of the first and second computing unit and, for example, a first computer program of the first computing unit can be changed weekly and a second computer program of the second computing unit can be changed annually. These different change cycles are advantageous because cybersecurity functions need to be changed frequently and quickly in practice, whereas safety functions are usually only changed rarely due to the hardly changing requirements. If safety functions are changed, this usually requires a new approval for the device equipped with the changed safety functions.

The first computing unit comprises the communication module, which provides secure communication of the device according to the invention with external communication partners by means of cybersecurity functions. The communication module comprises a first interface that is suitable for receiving incoming data from an external communication partner. It is also conceivable that the first interface is configured to send data to external communication partners. The incoming data is checked by the communication module. As mentioned above, such a check can include authentication of the communication partner and/or checking the data, whereby, for example, encrypted data can also be decrypted. Further measures for checking the data in terms of information security are conceivable.

The second computer unit comprises an alarm module that performs a safety function and evaluates a hazardous situation. A hazardous situation is, for example, a violation of a limit value (threshold value) for a gas concentration or a ventilation parameter. In the case of the alarm module and also in the other modules mentioned, such as the sensor module, communication module, user interaction module or memory module, a module is preferably understood to be a computer program product that implements a cybersecurity function, safety function or an extended function on a computer unit. The alarm module generates an information signal that indicates whether a dangerous situation exists. Such an information signal can be in the form of an analog and/or digital information signal. For example, an analog information signal controls an optical, acoustic and/or haptic alarm unit in the form of an LED, a horn and/or a vibration motor. A digital information signal controls, for example, a display unit in the form of a display and/or is transmitted via a digital interface to an external communication partner for further processing.

The second interface described above connects the first and second computing units so that they can exchange data with each other. The data exchange takes place at least from the first computing unit to the second computing unit. This makes it possible for incoming data, which has previously been checked by the communication unit of the first computing unit, to be forwarded to the second computing unit and thus to the alarm module, which generates an information signal. In an advantageous way, parameters of the alarm module that have an influence on the information signal can be changed, for example. Such parameters can, for example, include changed alarm thresholds or influence the alarm behavior of the alarm module. It is also conceivable that the incoming data causes the alarm module to generate an information signal taking this data into account. For example, it is conceivable that an alarm signal is sent to the device according to the invention, which is first checked by the first computing unit in terms of information security and then output by the second computing unit and the alarm module in terms of operational security, for example, as described above, an optical, acoustic and/or haptic alarm unit is activated.

The second interface is configured in such a way that only data intended for data transmission can be transmitted from the first to the second computing unit and/or from the second to the first computing unit. It is therefore a defined interface, whereby the possible data was defined during development. This results in a decoupling of the first and second computing unit as well as the communication module and the alarm module, whereby an influence is only possible through a defined data exchange via the second interface. In an advantageous way, for example, an independent running capability of the first and second computing unit can be implemented, so that, as described above, a change in the functionality of the first computing unit, in particular the functionality of the communication module, can be changed independently of the functionality of the second computing unit, in particular the functionality of the alarm module, and vice versa.

The particular advantage of the device according to the invention is that the device is suitable for executing cybersecurity and safety functions, whereby the execution of the cybersecurity and safety functions are independent of each other due to the hardware separation of the first and second computing units in such a way that they can be changed separately from each other. This makes it possible, for example, to change the cybersecurity functions without affecting the safety functions, so that it is not necessary to change the safety function due to a change in the cybersecurity functions. Advantageously, the cybersecurity functions of the first computing unit can be changed at short notice without, for example, having to carry out a new, often lengthy approval process for the safety functions of the second computing unit.

In a preferred embodiment of the device, the first computing unit is configured to access a first data memory, and the second computing unit is configured to access a second data memory. Accessing the respective data memory involves reading and/or writing data.

A data memory refers to a memory area for storing digital data on one or more data storage media (memory media) or data carriers. The first and second data memories are preferably configured as semiconductor memories. Such a semiconductor memory is, for example, a volatile or preferably a non-volatile memory. The first data memory comprises a semiconductor memory and the second data memory comprises a separate semiconductor memory. It is also conceivable that the first and second data memory comprise a common semiconductor memory or that the respective data memory comprises several semiconductor memories.

The first computing unit is configured to read data from the first data memory and/or write data to the first data memory. For example, the data in the first data memory is data received via the first interface and/or computer program data for executing the cybersecurity functions.

The second computing unit is configured to read data from the second data memory and/or write data to the second data memory. For example, the data in the second data memory is computer program data for executing the safety functions and/or parameters for evaluating an alarm situation.

According to a preferred embodiment of the device, the first data memory and the second data memory are non-overlapping (segmented). The memory area of the first data memory is separated from the memory area of the second data memory. As a result, data from the first data memory can only be accessed by the first computing unit and data from the second data memory can only be accessed by the second computing unit. The first data memory and the second data memory may be comprised by a data storage medium/media (memory unit) with the first data memory and the second data memory being non-overlapping or may be comprised by separate data storage medium/media (memory units)—not shared separate data storage medium/media. In an advantageous way, the separation of the data of the first data memory and the second data memory ensures that the respective computing unit only has access to a memory area intended for it and can therefore only read and/or write this data. Mutual interference between the computing units, and therefore also between the execution of the safety and cybersecurity functions, through direct access to data in the respective other data memory is therefore excluded.

It is conceivable that the device also comprises a memory protection unit (MPU), which protects the first and/or second data memory from unauthorized access. Unauthorized access would be, for example, the reading of data from the second data memory by the first computing unit or the writing of data from the first computing unit to the first data memory.

In a preferred embodiment of the device, the first computing unit is configured to execute the at least one cybersecurity function independently of the second computing unit and the second computing unit is configured to execute the at least one safety function independently of the first computing unit. Such decoupling of the execution of the functions of the first and second computing units ensures that the at least one cybersecurity function and the at least one safety function can be executed as intended. A malfunction or interruption of the execution of the at least one cybersecurity function by the second computing unit and/or the execution of the at least one safety function by the first computing unit is therefore excluded. The particular advantage of this is the increased reliability of the execution of the respective function, whereby the at least one safety function can be executed, for example, even in the event that the first computing unit and/or its function has a fault or has failed. It is preferably ensured that data transmission between the first and second computing units is prevented at least by the second computing unit, for example by the second computing unit detecting the malfunction of the first computing unit and/or its function and blocking data transmission. Furthermore, the at least one cybersecurity function can also be executed in cases in which the second computing unit and/or its function is disrupted or has failed. In the latter case, a further advantage is that the malfunction or failure of the second computing unit and/or its function can preferably be detected by the first computing unit, which can then forward this information to external communication partners by the communication module via the first interface. Such forwarding of information advantageously ensures increased operational safety, since it is possible to react to the malfunction or failure and, for example, order the device to be repaired or to leave a presumed danger zone (hazardous area).

In any case, the intended execution of the at least one cybersecurity function of the first computing unit and the safety function of the second computing unit cannot be influenced by a malfunction or failure of the respective other computing unit and/or its function.

According to a preferred embodiment of the device, the second computing unit comprises a sensor module for recording sensor data. In order to assess immediately dangerous situations, it is necessary to determine information about current conditions. The sensor module for recording sensor data, like the alarm module for generating an information signal, is also used for operational safety. Measurements are taken by one or more sensors and the measurement data is recorded by the sensor module for further processing. A common application example is the evaluation of an alarm situation using the recorded measurement data and the output of the result of the evaluation. The sensor module is adapted to the respective sensor. For example, the sensor module is configured to record sensor data relating to a gas concentration, a temperature, a respiratory rate and/or a tidal volume. The sensor module is preferably part of a microprocessor of the second computing unit, which comprises the alarm module. It is conceivable that the sensor module and the alarm module are components of separate units, for example two microprocessors or two processor cores, of the second computing unit. It is also conceivable that the second computing unit comprises several sensor modules so that the sensor data from different sensors can be recorded. By recording sensor data, the sensor module makes it possible to evaluate a direct hazard situation, for example in the immediate vicinity of the device, in an advantageous way.

In a preferred embodiment of the device, the first computing unit and/or the second computing unit comprises a memory module for managing data on a storage medium. The respective memory module is adapted to the type of storage medium. A distinction must be made between storage media that can only be accessed by a computing unit of the device, for example the RAM (random access memory) of a microprocessor of the first computing unit, and storage media that can also be accessed by other computing units that do not belong to the device, for example a memory card (SD card) that can be removed from the device. In the first case, the memory module is part of the first and/or second computing unit. In the second case, the memory module is part of the first computing unit, since in this case, for example, manipulation of the data by a computing unit not belonging to the device is possible and corresponding cybersecurity functions are necessary to prevent or at least detect such manipulation. A suitable cybersecurity function is, for example, the encryption of the data on the storage medium so that it is ensured that only authorized users with a corresponding security key can read and/or change this data. In an advantageous way, the memory module can therefore be adapted to different types of storage media and, depending on the respective storage medium, is part of the suitable computing unit of the device.

According to a preferred embodiment, the device has a third computing unit which comprises a user interaction module for inputting and/or outputting information. Furthermore, the third computing unit can be connected or is connected to the first and/or second computing unit for data exchange. The user interaction module comprises functions that serve the convenient operation and use of the device and have no direct influence on information security or operational safety.

The input of information is limited in such a way that manipulation of the first and second computing units and their cybersecurity and safety functions is not possible. As a result, the first and second computing units are independent of the third computing unit and the information security of the device is still guaranteed. The output of information by the third computing unit only includes information that is not essential for operational security and/or at least one additional piece of information that is displayed. For example, it is conceivable that information about a detected hazardous situation, for example the violation of a limit value for at least one gas concentration or a ventilation parameter, is generated by the alarm module of the second computing unit, which preferably activates an optical, acoustic and/or haptic alarm unit in the form of an LED, a horn and/or a vibration motor and additionally provides the information about the detected hazardous situation to the third computing unit. For example, the third computing unit is configured to control a display and show the information about the detected hazardous situation on the display. Such an output of the information by the third computing unit represents an additional information display that can be regarded as optional in terms of operational safety, as it is redundant to the control of the alarm unit by the alarm module and therefore does not have to be regarded as a safety function. In this example, the safety function in terms of operational safety, in this case the warning of or in a dangerous situation, is ensured by the alarm module of the second computer unit and the activation of the visual, acoustic and/or haptic alarm unit.

In an advantageous way, the third computing unit offers an extension of the functional scope of the device without influencing the first and second computing units and the cybersecurity and safety function. As a result, the cybersecurity function and the safety function can be changed independently of the third computing unit and its extended functions.

Furthermore, the invention relates to a process for executing cybersecurity functions with respect to information security and safety functions with respect to operational safety on a device with a first computing unit and with a second computing unit. The process comprises the following steps:
receiving and checking data with a communication module of the first computing unit,
storing the data in a first data memory and/or transferring the data to a second computing unit,
evaluating the data relating to an alarm situation with an alarm module of the second computing unit, and
generating an information signal by the alarm module.

The process is suitable for being carried out by the device described above in accordance with the invention or one of the embodiments described above. The first computing unit performs at least one cybersecurity function and the second computing unit performs at least one safety function. To protect information security, data received by the communication module is checked, for example to determine whether the data has been sent by a sender authorized to communicate or whether the integrity of the data is guaranteed, i.e. whether the data is correct, complete and consistent. It is also conceivable that the data has been received in encrypted form and the communication module decrypts the data.

In a further process step, the data whose information security has been checked is stored and/or transmitted to the second computing unit. For transmission, the device has a second interface that connects the first computing unit to the second computing unit for data exchange. The data can therefore be stored in the data memory, to which only the first computing unit has access, and forwarded to the second computing unit at a later time or directly, for example. The data can, for example, contain information about a detected hazardous situation sent to the device by an external control room or an external monitoring device.

In a further process step, the tested and transmitted data is evaluated by the alarm module of the second computing unit. As previously mentioned, the data may, for example, be information about a hazardous situation. Other information is also conceivable, for example information on the configuration of the alarm module, such as limit values or alarm behavior, as well as other settings or information relating to a safety function.

In a next step, the alarm module generates an information signal based on the evaluation. This information signal can be used to trigger an audible and/or visual alarm unit or be a digital signal that is sent to a control room via the communication module, for example.

Advantageously, the process is suitable for executing a cybersecurity function and a safety function, whereby these are executed on different computing units and are independent of each other, so that in particular the cybersecurity function can be changed without having to change the safety function.

In a preferred embodiment of the process, a sensor measured value is determined using a sensor module of the second computing unit. This sensor measured value is preferably determined using the raw data from a sensor belonging to the device or connected to it. It is also conceivable that the sensor measured value is determined using data from an external communication partner that has sent this data to the device. Furthermore, the sensor measured value is evaluated by the alarm module with regard to an alarm situation. The sensor module performs a safety function in terms of operational safety and determines, for example, a sensor measured value of a gas concentration or a breathing rate. The sensor measured value is then compared by the alarm module with a limit value, for example, in order to determine whether an alarm situation is present. An alarm situation can exist, for example, if a sensor reading violates the limit value. The process offers the particular advantage that the safety functions, in this case the determination and evaluation of a sensor measured value, are carried out jointly on a second computing unit so that it is independent of a first computing unit, which carries out at least one cybersecurity function.

In a preferred embodiment of the process, information of the second computing unit is stored in a second data memory, wherein the second data memory and the first data memory are non-overlapping. As described above, a data memory refers to a certain memory area of one or more storage media, for example semiconductor memory. The first and second data memories are configured such that they have no common data content. This means that data is stored either in the first or in the second data memory. As a result, the first computing unit cannot access the data in the second data memory and the second computing unit cannot access the data in the first data memory. In an advantageous way, the data is therefore separated from each other in such a way that only one of the two computing units has access to it. This access restriction helps to decouple the first and second computing units and thus the cybersecurity and safety functions.

It is conceivable that the first and second data memories are protected against unauthorized access by a memory protection unit (MPU). Unauthorized access would be, for example, reading data from the first computing unit from the second data memory or writing data from the first computing unit to the first data memory.

According to a preferred embodiment of the process, information is received and/or output with a user interaction module of a third computing unit of the device, with data transmission preferably taking place between the second and third computing units. The user interaction module preferably comprises functions which serve the convenient operation and use of the device and have no direct influence on information security or operational safety. As described above, the first and second computing units are independent of the third computing unit, so that the intended execution of the cybersecurity functions and the safety functions by the first and second computing units cannot be interfered with by the third computing unit. Furthermore, the cybersecurity functions and the safety functions can be changed independently of the functions of the third computing unit and the functions of the third computing unit can be changed independently of the functions of the first computing unit (cybersecurity functions) and second computing unit (safety functions). In an advantageous way, the third computing unit offers an extension of the functional scope of the device without influencing the first and second computing units. As a result, the cybersecurity function can be changed independently of the third computing unit and its extended functions.

Further features, tasks and effects of the invention can be seen from the following description of specific embodiments and the accompanying figures. Examples of embodiments of the invention are described without limiting the general idea of the invention.

Furthermore, the invention relates to a gas measuring device with a device which is configured according to one of the embodiments described above and/or which can carry out a process according to at least one of the embodiments described above.

The proposed gas measuring device can be configured as a mobile or stationary, i.e. immobile, gas measuring device and comprises the device and preferably an alarm unit and one or more sensors, whereby the alarm unit and the sensors are connected to the second computing unit of the device for information exchange. The alarm unit can have an acoustic and/or optical signal transmitter. The sensors may be capable of measuring various toxic or combustible (flammable) gases.

The gas measuring device can be used reliably in terms of information security and operational safety in an advantageous way, whereby cybersecurity functions and safety functions can be executed independently of each other. The separation of these functionalities ensures reliable operation and efficient maintenance of the gas measuring device. In particular, maintenance refers to the need to change and adapt the cybersecurity functions to new requirements and new technologies. In a particularly advantageous way, a change to the cybersecurity functions, for example an adaptation to newer security standards, can be carried out without affecting the safety functions, whereby a new approval test of the safety functions can be omitted and the changes to the cybersecurity functions are available after their implementation.

Furthermore, the invention relates to a ventilator or anesthesia device with a device which is configured according to one of the embodiments described above and/or which can carry out a process according to at least one of the embodiments described above.

The proposed ventilator or anesthesia device comprises the device and preferably an alarm unit and one or more sensors, wherein the alarm unit and the sensors are connected to the second computing unit of the device for information exchange. The alarm unit may comprise an acoustic and/or optical signaling device. The sensors may be able to detect various ventilation parameters.

In an advantageous way, the ventilator or anesthesia device can be used reliably in terms of information security and operational safety, whereby cybersecurity functions and safety functions can be executed independently of each other. The separation of these functionalities ensures reliable operation and efficient maintenance of the ventilator or anesthesia device. In particular, maintenance refers to the need to change and adapt the cybersecurity functions to new requirements and new technologies. In a particularly advantageous way, a change to the cybersecurity functions, for example an adaptation to newer security standards, can be carried out without affecting the safety functions, whereby a new approval test of the safety functions can be omitted and the changes to the cybersecurity functions are available after their implementation.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic representation of an embodiment of the device according to the invention;

FIG. 2 is a schematic representation of an embodiment of the gas measuring device according to the invention; and

FIG. 3 is a schematic representation of an embodiment of the ventilator or anesthesia device according to the invention.

### DESCRIPTION OF PREFERRED EMBODIMENTS

Referring to the drawings, in the following, embodiments of the invention are described in detail with reference to the attached figures. Similar components in several figures are each provided with the same reference symbols.

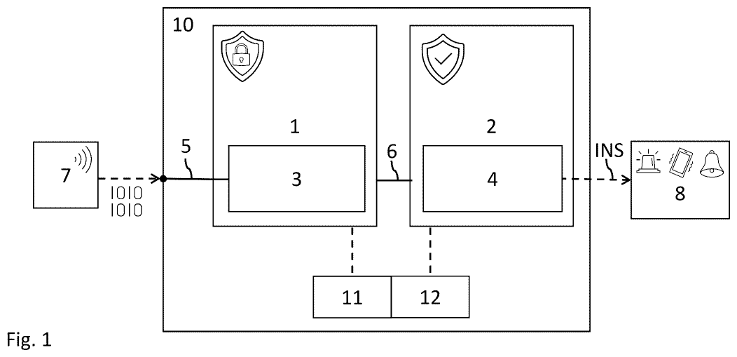

FIG. 1 shows a preferred embodiment of the device 10 according to the invention by means of a schematic representation with a first computing unit 1 and a second computing unit 2, which are connected to each other via a second interface 6 for data exchange. The first computing unit 1 is configured to perform a cybersecurity function and comprises a communication module 3, which has a first interface 5. The first interface 5 is configured to receive data from an external communication partner 7, in this case wirelessly transmitted data, as indicated by the dashed arrow. The communication module 3 is configured to check incoming data. The second computing unit 2 is configured to perform a safety function and comprises an alarm module which is configured to generate an information signal INS. The alarm module 4 is connected to an alarm unit 8 for data exchange, as indicated by the dashed arrow, whereby the alarm unit 8 is configured to generate an acoustic, haptic and/or visual alarm.

The first and second computing units 1, 2 are each configured as microprocessors and are connected to each other for data exchange via the second interface 6 in the form of a UART interface (Universal Asynchronous Receiver Transmitter interface). Data from an external communication partner 7, for example in the form of a control room, can be received via the first interface 5. The data from the external communication partner 7 can, for example, contain alarm information, i.e. information as to whether a hazardous situation exists or not. The communication module 3 is configured to check the data from the external communication partner 7. This involves authenticating the external communication partner 7 and checking the integrity of the data.

If the external communication partner 7 has sent alarm information, the communication module 3 receives this alarm information and checks it in terms of information security. If the check shows that the external communication partner is trustworthy and/or known and the content of the data, i.e. the alarm information, is correct in terms of data integrity, the first computing unit 1 forwards the alarm information to the second computing unit 2 via the second interface 6. The alarm module 4 of the second computing unit 2 accepts the alarm information, evaluates it and triggers the alarm unit 8 in accordance with the alarm information. If, however, the check shows that the external communication partner 7 is not trustworthy and/or not known, the alarm information is discarded and not forwarded to the second computing unit.

The first computing unit 1 is connected to a first data memory 11 and the second computing unit 2 is connected to a second data memory 12. The data memories 11 and 12 are each configured as independent semiconductor memories (independent semiconductor storage devices).

In the event that the external communication partner 7 has sent information relating to a change in the mode of operation of the communication module 3, whereby this is a software update, and the authentication has been successfully performed by the communication module 3, the communication module 3 stores this information in the first data memory 11 and the first computing unit 1 then performs a software update of the communication module 3, whereby the mode of operation of the alarm module 4 is not affected.

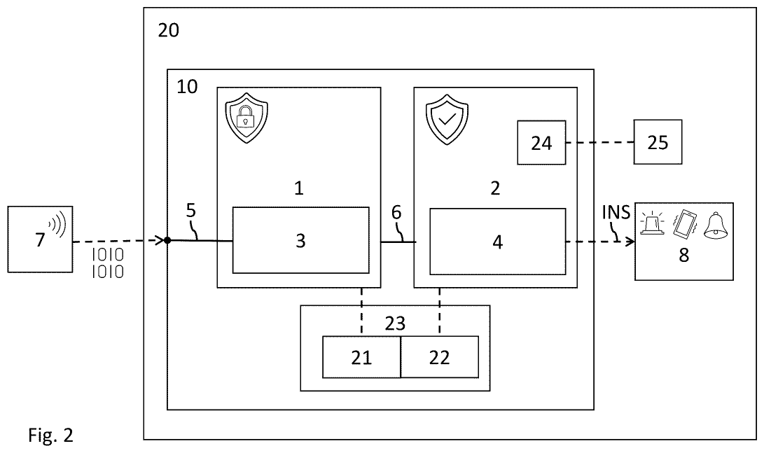

FIG. 2 shows a preferred embodiment of the gas measuring device according to the invention with an embodiment of the device 10 according to the invention, a gas sensor 25 and an alarm unit 8. The device 10 essentially corresponds to the device 10 as shown and previously described in FIG. 1. In addition, the device 10 comprises a semiconductor memory 23 with a first data memory 21 and a second data memory 22, wherein the first data memory 21 can be accessed by the first computing unit 1 and the second data memory can be accessed by the second computing unit 2, shown by means of dashed lines. The data memories 21, 22 form two separate memory areas of the semiconductor memory 23, which do not overlap, i.e. are separate from one another. Furthermore, the second computing unit 2 of the device 10 comprises a sensor module 24 for recording sensor data from the gas sensor 25. The sensor module 24 is connected to the sensor 25 to receive a sensor signal, shown by the dashed line. It is conceivable, but not shown in FIG. 2, that the sensor module 24 or several sensor modules record several sensor signals from several gas sensors.

As described above, the communication module 3 of the first computer unit 1 is configured to check incoming data from an external communication partner 7, whereby the data is received via a first interface 5. The external communication partner 7 is, for example, an external control room for monitoring and controlling gas measuring devices. The data can, for example, be alarm information or alarm parameters for configuring the alarm module 4 of the second computing unit 2. The first and second computing units are connected to each other via the second interface for data exchange, so that the aforementioned alarm information or alarm parameters can be transmitted to the second computing unit 2 and thus to the alarm module 4. Before such a transmission takes place, as in the description of FIG. 1, the incoming data, i.e. the alarm information and the alarm parameters, are checked by the communication module 3 of the first computing unit 1 in terms of cybersecurity. Information required for the check is stored on the first data memory 21 and can be accessed by the first computing unit. Such information includes, for example, a security key for checking incoming encrypted data.

If the incoming data is alarm information, for example information that a hazardous situation exists, this is transmitted via the second interface 6 to the second computing unit 2 and the alarm module 4. The second computing unit 2 and the alarm module 4 perform a safety function in terms of operational safety, which involves generating the information signal INS, which warns a user (not shown) of the gas measuring device 20 of a hazardous situation. In this case, an information signal INS is generated on the basis of the alarm information and transmitted to the alarm unit 8, which comprises an LED, a vibration motor and a horn (and/or loudspeaker) and generates an acoustic, haptic and/or visual alarm. The parameters of how the information signal INS is generated are stored in the second data memory 22. These parameters include, for example, signal patterns for an alarm and/or limit values for gas concentrations and can only be accessed by the second computing unit. This ensures that the first computing unit 1 has no direct influence on these parameters and thus on the safety functions of the second computing unit 2. The signal pattern determines how an alarm is output by the alarm unit 8 of the gas measuring device 20, i.e. the way in which the LED, the vibration motor and/or the horn signal the information signal INS.

Alternatively, or additionally, the second computing unit 2 is configured to generate an information signal INS on the basis of sensor data from the gas sensor 25. The sensor module 24 records the sensor data of the gas sensor 25 and generates a sensor measured value, in this case a gas concentration value. This gas concentration value is evaluated by the alarm module 4 by comparing it with a limit value. Based on this evaluation, the alarm module generates an information signal INS. As described above, the limit value for the gas concentration is a parameter that is stored in the second data memory 22 and can only be accessed by the second computing unit 2.

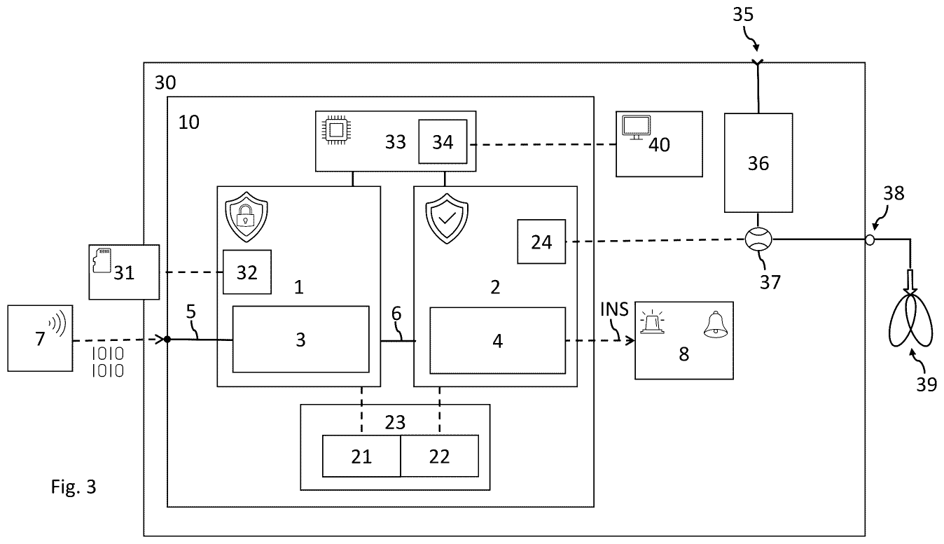

FIG. 3 shows a preferred embodiment of the ventilator or anesthesia device according to the invention with an embodiment of the device 10 according to the invention, an inlet 35 for introducing a respiratory gas, a ventilator unit 36, a volume flow sensor 37, an outlet 38 for providing a respiratory gas flow for ventilating a patient 39 as well as an alarm unit 8, a monitor 40 and a storage medium in the form of an SD card 31. The device 10 essentially corresponds to the device 10 as shown in FIG. 2 and described above. In addition, the first computing unit 1 of the device 10 comprises a memory module 32 for managing the data on the SD card 31 and a third computing unit 33 with a user interaction module 34 for inputting and/or outputting information. This information is received by and/or displayed on the monitor 40 in the form of a touch-sensitive screen.

The range of functions of the device 10 essentially corresponds to the range of functions of the device 10 as shown in FIG. 2 and described above. However, the sensor module 24 is configured to record the sensor data of the volumetric flow sensor 37 and to generate a volumetric flow value. Based on the volume flow rate value, an information signal INS is generated by the alarm module by means of comparison with a corresponding limit value and transmitted to the alarm unit 8, which comprises an LED and a horn, for signaling the information signal.

The external communication partner 7 in FIG. 3 is, for example, a monitoring station in a hospital that is configured to communicate with the ventilator or anesthesia device.

In addition to the device 10 shown and described in FIG. 2, the device 10 in FIG. 3 is configured to exchange information with the monitor 40 of the ventilator or anesthesia device 30 by means of the third computing unit 33 and the user interaction module 34. The third computing unit 33 is connected to the first and second computing units 1, 2 via an interface for data exchange. This ensures that the cybersecurity functions of the first computing unit 1 and the safety functions of the second computing unit 2 are independent of the functionality of the third computing unit 33. For example, the measured volume flow values of the sensor module 24 can be transmitted from the second computing unit 2 to the third computing unit 33, processed for display by the user interaction module 34 and displayed on the monitor 40. Furthermore, information about an input from a user (not shown) can be forwarded via the monitor 40 to the first and/or second computing unit 1, 2, whereby it can, for example, be a matter of querying information (information request) which is then displayed on the monitor.

In addition to the device 10 shown and described in FIG. 2, the device 10 in FIG. 3 is configured to manage data of a storage medium in the form of an SD card 31 by means of the memory module 32 of the first computing unit 1. Since the SD card 31 is a storage medium that can be removed from the ventilator or anesthesia device 30 and whose data can potentially be manipulated by unauthorized persons, the data of the SD card 31 is checked by the first computing unit 1 in terms of cybersecurity. For example, the data integrity is checked by the first computing unit 1 when the data is read from the SD card. This ensures information security when the SD card 31 is used as a storage medium.

While specific embodiments of the invention have been shown and described in detail to illustrate the application of the principles of the invention, it will be understood that the invention may be embodied otherwise without departing from such principles.

### LIST OF REFERENCE NUMBERS

1 First computing unit
2 Second computing unit
3 Communication module
4 Alarm module
5 First interface
6 Second interface
7 External communication partner
8 Alarm unit
INS Information signal
11 First data memory
12 Second data memory
20 Gas measuring device
21 First data memory
22 Second data memory
23 Semiconductor memory
24 Sensor module
25 Gas sensor
30 Ventilator or anesthesia device
31 SD card
32 Memory module
33 Third computing unit
34 User interaction module
35 Inlet
36 Ventilator unit
37 Volume flow sensor
38 Outlet
39 Patient
40 Monitor

What is claimed is:

1. A device for executing cybersecurity functions with respect to information security and safety functions with respect to operational safety, the device comprising:
a first computing unit configured to execute at least one of the cybersecurity functions, the first computing unit comprising a communication module which has a first interface and is configured to check incoming data;
a second computing unit configured to execute at least one of the safety functions, the second computing unit comprising an alarm module which is configured to generate an information signal; and
a second interface configured for data exchange between the first computing unit and the second computing unit, wherein the first computing unit and the second computing unit are data exchange connected to one another via the second interface.

2. A device according to claim 1, wherein the first computing unit is configured to access a first data memory, and the second computing unit is configured to access a second data memory.

3. A device according to claim 2, wherein the first data memory and the second data memory are comprised by a data storage medium with the first data memory and the second data memory being non-overlapping or are comprised by separate data storage media that are not shared by the first and second computing units.

4. A device according to claim 1, wherein the first computing unit is configured to execute the at least one cybersecurity function independently of the second computing unit and the second computing unit is configured to execute the at least one safety function independently of the first computing unit.

5. A device according to claim 1, wherein the second computing unit comprises a sensor module for recording sensor data.

6. A device according to claim 1, wherein the first computing unit and/or the second computing unit comprises a memory module for managing data on a data storage medium.

7. A device according to claim 1, further comprising a third computing unit, wherein the third computing unit comprises a user interaction module for inputting and/or outputting information.

8. A device according to claim 6, wherein the third computing unit is connected to the first computing unit and/or second computing unit for data exchange.

9. A device according to claim 1, wherein the device is comprised by a gas measuring device.

10. A device according to claim 1, wherein the device is comprised by a ventilator or an anesthesia device.

11. A process for executing cybersecurity functions with respect to information security and safety functions with respect to operational safety on a device comprising a first computing unit and a second computing unit, the process comprising the steps of:
receiving and checking data with a communication module of the first computing unit;
storing the data in a first data memory and/or transmitting the data to the second computing unit,
evaluating the data relating to an alarm situation with an alarm module of the second computing unit; and
generating an information signal by the alarm module.

12. A process according to claim 11, further comprising the steps of:
determining a sensor measured value with a sensor module of the second computing unit; and
evaluating the sensor measured value with regard to an alarm situation by the alarm module.

13. A process according to claim 11, further comprising the step of storing information of the second computing unit in a second data memory, wherein the second data memory and the first data memory are non-overlapping.

14. A process according to claim 11, further comprising the step of receiving and/or outputting information with a user interaction module of a third computing unit of the device.

15. A gas measuring device comprising:
a device for executing cybersecurity functions with respect to information security and safety functions with respect to operational safety, the device comprising:
a first computing unit configured to execute at least one of the cybersecurity functions, the first computing unit comprising a communication module which has a first interface and is configured to check incoming data;
a second computing unit configured to execute at least one of the safety functions, the second computing unit comprising an alarm module which is configured to generate an information signal; and
a second interface configured for data exchange between the first computing unit and the second computing unit, wherein the first computing unit and the second computing unit are data exchange connected to one another via the second interface.

16. A gas measuring device according to claim 15, wherein the first computing unit is configured to access a first data memory and the second computing unit is configured to access a second data memory.

17. A gas measuring device according to claim 16, wherein the first computing unit and/or the second computing unit comprises a memory module for managing data on a data storage medium or on data storage media, wherein the first data memory and the second data memory are comprised by the data storage medium or the data storage media with the first data memory and the second data memory being non-overlapping or are comprised by separate data storage media that are not shared by the respective memory module.

18. A gas measuring device according to claim 15, wherein the first computing unit is configured to execute the at least one cybersecurity function independently of the second computing unit and the second computing unit is configured to execute the at least one safety function independently of the first computing unit.

19. A gas measuring device according to claim 15, wherein the second computing unit comprises a sensor module for recording sensor data.

20. A gas measuring device according to claim 15, further comprising a third computing unit, wherein the third computing unit comprises a user interaction module for inputting and/or outputting information and wherein the third computing unit is connected to the first computing unit and/or second computing unit for data exchange.
